(19) United States
(12) Patent Application Publication
(10) Pub. No.: US 2026/0229061 A1
(43) Pub. Date: Aug. 6, 2026

(54) INFORMATION PROCESSING APPARATUS, INFORMATION PROCESSING METHOD, AND NON-TRANSITORY RECORDING MEDIUM

(71) Applicants: NEC Corporation, Tokyo (JP); NEC Platforms, Ltd., Kanagawa (JP)

(72) Inventors: Kazuhiro TAKEUCHI, Kanagawa (JP); Toshinobu OGATSU, Tokyo (JP)

(73) Assignees: NEC Corporation, Tokyo (JP); NEC Platforms, Ltd., Kanagawa (JP)

(21) Appl. No.: 19/149,588

(22) PCT Filed: Jan. 23, 2023
(86) PCT No.: PCT/JP2023/001950

§ 371 Date: Jul. 21, 2025

(51) Int. Cl. G06V 40/19; G06T 7/70; G06V 10/10; H04N 23/60

(52) U.S. Cl. CPC G06V 40/19; G06T 7/70; G06V 10/16; H04N 23/60; G06T 2207/30201; G06V 2201/07

(57) ABSTRACT

An information processing apparatus including: a first sensor; a second sensor; an occlusion object that occludes a part of a detection range of the first sensor and a part of a detection range of the second sensor; and a detection unit that detects a target according to a detection result of the first sensor in case the part of the detection range of the first sensor is occluded by the occlusion object and a detection result of the second sensor in case the part of the second detection range of the second sensor is occluded by the occlusion object.

### TECHNICAL FIELD

This disclosure relates to the technical field of information processing apparatus, information processing methods, and recording media.

### BACKGROUND ART

Patent Literature 1 describes a technology in which the human sensor detects the detection target, the operation unit receives operation instructions, and the control unit executes setting processing to control the human sensor. The setting process indicates a process for adjusting the detection degree of a human sensor unit according to the detection accuracy, where the detection accuracy indicates the relationship between the number of times the <human sensor> unit detects the target object within the first unit time and the number of times the operation unit receives operation instructions, and the detection degree indicates the degree of detection of the target object.

Patent Literature 2 describes a technology in which, in response to a signal received from a network camera apparatus, a power supply control means returns the power supply from a power saving state to a first power state in which image formation is possible, and when user information authenticated by the network camera apparatus is notified, completes a login process for a person approaching the image forming apparatus, and when user information is not notified, executes a login process for the person.

Patent Literature 3 describes a technology in which a reflective film that reflects infrared rays is provided at least at one location in at least a part of the area where an infrared ray-transmitting filter mounted on a shield case and a surface electrode pair face each other, and the infrared ray-transmitting filter and the surface electrode pair are arranged in close proximity to each other.

Patent Literature 4 discloses an infrared detection body comprising two piezoelectric infrared detection elements that generate electric charges in response to the light flux of incident infrared rays, the two elements being connected so that their polarization directions face each other, and a case that houses the infrared detection body and has an entrance window at the front of the infrared detection body through which infrared rays emitted from the object to be detected enter. an infrared shielding body that shields infrared rays from the entrance window is provided in a tilted state with respect to the parallel direction of the two elements.

### CITATION LIST

### Patent Literature

Patent Literature 1: JP2019-166674A
Patent Literature 2: JP2015-153293A
Patent Literature 3: JP2012-177680A
Patent Literature 4: JPH04-346037A

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: a first sensor; a second sensor; an occlusion object that occludes a part of a detection range of the first sensor and a part of a detection range of the second sensor; and a detection unit that detects a target according to a detection result of the first sensor in case the part of the detection range of the first sensor is occluded by the occlusion object and a detection result of the second sensor in case the part of the second detection range of the second sensor is occluded by the occlusion object.

An information processing method according to an example aspect includes detecting a target according to a detection result of a first sensor in case a part of a detection range of the first sensor is occluded by an occlusion object and a detection result of a second sensor in case a part of a detection range of the second sensor is occluded by the occlusion object, wherein the occlusion object occludes the part of the detection range of the first sensor and the part of the detection range of the second sensor.

A recording medium according to an example aspect is a recording medium on which a computer program that allows a computer to execute an information processing method is recorded, the information processing method including detecting a target according to a detection result of a first sensor in case a part of a detection range of the first sensor is occluded by an occlusion object and a detection result of a second sensor in case a part of a detection range of the second sensor is occluded by the occlusion object, wherein the occlusion object occludes the part of the detection range of the first sensor and the part of the detection range of the second sensor.

### BRIEF DESCRIPTION OF DRAWINGS

FIG. 1 is a plan view illustrating a configuration of an information processing apparatus according to this disclosure.

FIG. 2 is a plan view showing a configuration of a comparative example device equipped with a pyroelectric sensor.

FIG. 3 is a plan view illustrating a configuration of an information processing apparatus according to this disclosure.

FIG. 4 is a plan view illustrating a modified example of a configuration of an information processing apparatus according to this disclosure.

FIG. 5 is a plan view illustrating a modified example of a configuration of an information processing apparatus according to this disclosure.

FIG. 6 is a cross-sectional view illustrating a configuration of an imaging system according to this disclosure.

FIG. 7 is a block diagram illustrating a configuration of an imaging system according to this disclosure.

FIG. 8 is a flowchart illustrating a flow of an information processing operation of an imaging system according to this disclosure.

FIG. 9 is a block diagram illustrating a configuration of an imaging system according to this disclosure.

FIG. 10 is a flowchart illustrating a flow of an information processing operation of an imaging system according to this disclosure.

FIG. 11 is a block diagram illustrating a configuration of a recognition system according to this disclosure.

FIG. 12 is a flowchart illustrating a flow of an information processing operation of a recognition system according to this disclosure.

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### 1-1: Configuration of the Information Processing Apparatus 1

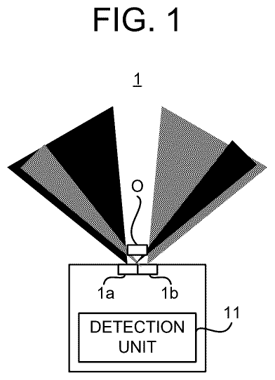

Referring to FIG. 1, the configuration of the information processing apparatus 1 according to the first embodiment will be described. FIG. 1 is a plan view showing the configuration of the information processing apparatus 1 according to the first embodiment.

As shown in FIG. 1, the information processing apparatus 1 includes a first sensor 1a, a second sensor 1b, an occlusion object O, and a detection unit 11. The occlusion object O occludes a part of a detection range of the first sensor 1a and a part of a detection range of the second sensor 1b. The detection unit 11 detects a target based on the detection result of the first sensor 1a, whose detection range is partially occluded by the occlusion object O, and the detection result of the second sensor 1b, whose detection range is partially occluded by the occlusion object O.

### 1-2: Technical Effects of the Information Processing Apparatus 1

The information processing apparatus 1 according to the first embodiment includes the occlusion object O that occludes the part of the detection range of the first sensor 1a and the part of the detection range of the second sensor 1b. The information processing apparatus 1 detects the target based on the detection result of the first sensor 1a, whose detection range is partially occluded by the occlusion object O, and the detection result of the second sensor 1b, whose detection range is partially occluded by the occlusion object O and therefore can detect the target with high accuracy.

### 2: Second Example Embodiment

Next, a second embodiment of the information processing apparatus, information processing method, and recording medium will be described. The second embodiment of the information processing apparatus, information processing method, and recording medium will be described using an information processing apparatus 2 to which the second embodiment of the information processing apparatus, information processing method, and recording medium is applied.

The information processing apparatus 2 according to this embodiment may be applied to a human sensor. In addition, a pyroelectric sensor may be adopted as the human sensor to which the information processing apparatus 2 is applied.

### 2-1: The Pyroelectric Sensor

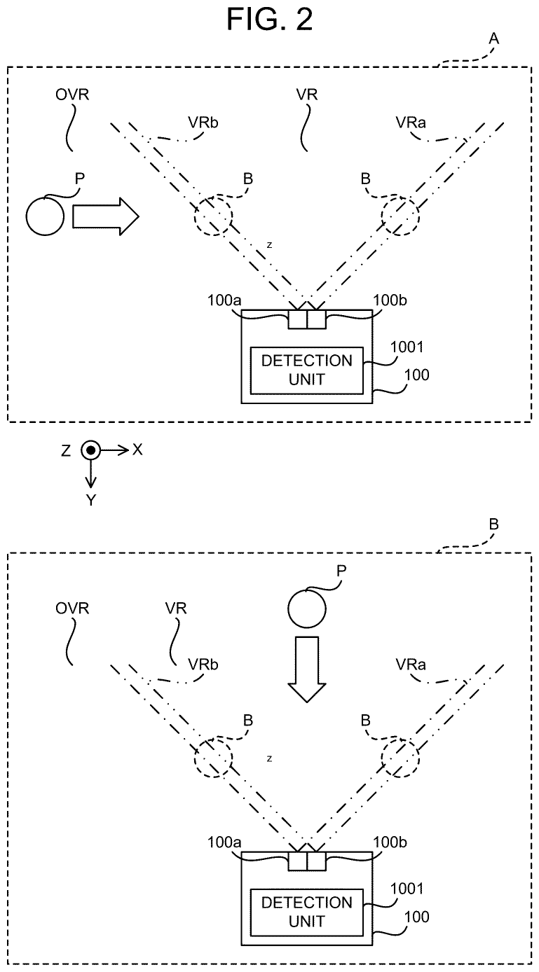

Referring to FIG. 2, the mechanism by which the pyroelectric sensor functions as the human sensor is shown. FIG. 2 is a plan view showing the configuration of an apparatus 100 as a comparative example equipped with the pyroelectric sensor. FIG. 2 is a top view of the apparatus 100 and a moving target person P.

As shown in FIG. 2, the apparatus 100 as the comparative example includes a first sensor 100a, a second sensor 100b, and a detection unit 1001. Each of the first sensor 100a and the second sensor 100b detects infrared rays separately. The first sensor 100a has a first viewing angle range VRa and detects infrared rays. The second sensor 100b has a second viewing angle range VRb and detects infrared rays. The first sensor 100a and the second sensor 100b each respond to infrared rays emitted by the target person P and output changes in infrared rays.

The detection unit 1001 extracts the difference between the detection results of the first sensor 100a and the second sensor 100b. The detection unit 1001 detects the presence of the target person P based on the detected infrared radiation changes. The detection unit 1001 detects the presence of the target person P within a viewing angle range VR based on the infrared radiation changes output by the first sensor 100a and the second sensor 100b. The detection unit 1001 extracts the difference between the detection results of the first sensor 100a and the second sensor 100b at a boundary B between the viewing angle range VR of the pyroelectric sensor and an outside viewing angle range OVR. The detection unit 1001 can detect the target person P with the highest accuracy in case the target person P moves across the boundary B between the viewing angle range VR of the pyroelectric sensor and the outside viewing angle range OVR.

In case the target person P moves from the outside viewing angle range OVR to the viewing angle range VR and arrives at the boundary B between the outside viewing angle range OVR and the viewing angle range VR, the apparatus 100 as the comparative example detects changes in infrared rays output by the first sensor 100a and the second sensor 100b, and detects that the target person P has entered the viewing angle range VR. Additionally, in case the target person P moves from the viewing angle range VR to the outside viewing angle range OVR and arrives at the boundary B between the viewing angle range VR and the outside viewing angle range OVR, the apparatus 100 as the comparative example detects the changes in infrared light output by the first sensor 100a and the second sensor 100b to detect the target person P has exited the viewing angle range VR.

Meanwhile, as shown in the plan view A of FIG. 2, in case the target person P is moving in the direction (X-axis direction) along which the first sensor 100a and the second sensor 100b are aligned, the apparatus 100 as the comparative example can detect the arrival of the target person P at the boundary B between the outside viewing angle range OVR and the viewing angle range VR. On the other hand, as shown in the plan view B of FIG. 2, in case the target person P moves in a direction different from the direction in which the first sensor 100a and the second sensor 100b are aligned, especially in case the target person P is moving toward the front of the apparatus 100 (along the Y-axis direction), the target person P does not arrive at the boundary B between the outside viewing angle range OVR and the viewing angle range VR, making it difficult for the apparatus 100 to detect the target person P.

### 2-2: Configuration of the Information Processing Apparatus 2

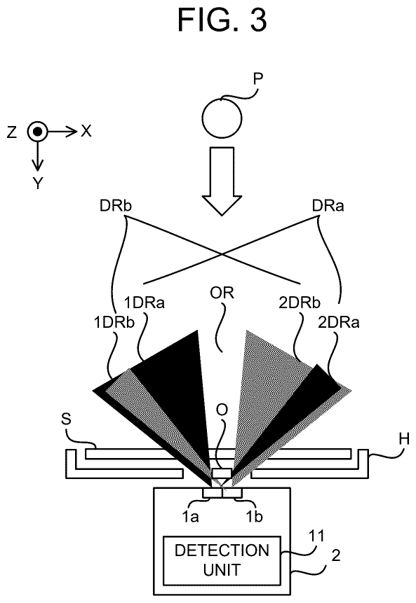

Referring to FIG. 3, the configuration of the information processing apparatus 2 according to the second embodiment will be described. FIG. 3 is a plan view showing the configuration of the information processing apparatus 2 according to the second embodiment.

As shown in FIG. 3, the information processing apparatus 2 includes a first sensor 1a, a second sensor 1b, an occlusion object O, and a detection unit 11. The information processing apparatus 2 differs from the apparatus 100 as the comparison example described above in that it includes the occlusion object O. The information processing apparatus 2 may further include a housing H and a protective screen S. However, the information processing apparatus 2 may not include at least one of the housing H and the protective screen S.

The first sensor 1a may be the same as the first sensor 100a. Additionally, the second sensor 1b may be the same as the second sensor 100b. The first sensor 1a and the second sensor 1b are aligned side by side. The direction in which the first sensor 1a and the second sensor 1b are aligned side by side is referred to as the X-axis direction. Furthermore, the direction facing the front of the information processing apparatus 2 is referred to as the Y-axis direction. The first sensor 1a and the second sensor 1b may be electrodes. The information processing apparatus 2 may also be described as having a pair of electrodes aligned side by side.

FIG. 3 shows an example of realizing the occlusion object O using the housing H. That is, a part of the housing H corresponding to the front of the pyroelectric sensor may be the occlusion object O.

The occlusion object O occludes the part of the detection range of the first sensor 1a and the part of the detection range of the second sensor 1b. In this embodiment, “range” may be a range related to a plane perpendicular to the vertical direction (Z-axis direction). In this embodiment, the detection range may be the range of the field of view of the sensor. The occlusion object O occludes the center of the front of the pyroelectric sensor and limits the detection range of the pyroelectric sensor. The range occluded by the occlusion object O is referred as an occlusion range OR. The occlusion object O occludes a part of the common detection range between the first sensor 1a and the second sensor 1b. The front of the pyroelectric sensor becomes the occlusion range OR due to the occlusion object O. The X-axis dimension of the occlusion object O and the Y-axis dimension of the occlusion object O may be adjustable. The X-axis dimension of the occlusion object O may be greater than the distance between the first sensor 1a and the second sensor 1b.

The range of the first sensor 1a that is not occluded by the occlusion object O is referred to as a first detection range DRa. Due to the occlusion object O, the first viewing angle range VRa of the first sensor 1a is restricted to the first detection range DRa. The first detection range DRa may include at least a first first detection range 1DRa and a first second detection range 2DRa. The range of the second sensor 1b that is not occluded by the occlusion object O is referred to as a second detection range DRb. The second viewing angle range VRb of the second sensor 1b is narrowed down to the second detection range DRb by the occlusion object O. The second detection range DRb may include at least a second first detection range 1DRb and a second second detection range 2DRb.

The detection unit 11 detects the target based on the detection results of the first sensor 1a, whose detection range is partially occluded by the occlusion object O, and the detection results of the second sensor 1b, whose detection range is partially occluded by the occlusion object O. The detection unit 11 may detect the target person P based on the difference between the detection result of the first sensor 1a whose detection range is partially occluded by the occlusion object O and the detection result of the second sensor 1b whose detection range is partially occluded by the occlusion object O. The detection unit 11 may detect the target person P based on the difference between the output of the first sensor 1a and the output of the second sensor 1b.

The detection unit 11 may detect the target person P existing at the boundary of at least one of the occlusion range OR, the first detection range DRa, and the second detection range DRb. In case the target person P moves from the occlusion range OR to one of the first detection range DRa and the second detection range DRb, and arrives at the boundary B between the occlusion range OR and one of the first detection range DRa and the second detection range DRb, the detection unit 11 detects that the target person P has entered one of the first detection range DRa and the second detection range DRb by sensing the change in infrared light output from the first sensor 1a and the second sensor 1b to detect that the target person P has entered one of the first detection range DRa and the second detection range DRb. The detection unit 11 can detect the target person P approaching from a distance in front of the information processing apparatus 2.

The detection unit 11 may detect the target person P existing at the boundary between one of the first detection range DRa and the second detection range DRb and an overlap area where the first detection range DRa and the second detection range DRb overlap. An area where at least a part overlaps is referred to as the overlap area.

The first first detection range 1DRa and the second first detection range 1DRb may overlap at least partially. Similarly, the first second detection range 2DRa and the second second detection range 2DRb may overlap at least partially. The detection unit 11 may detect the target person P existing at the boundary of the first detection range DRa and the second detection range DRb and the overlap area where the first first detection range 1DRa and the second first detection range 1DRb overlap. The detection unit 11 may detect the target person P located at the boundary between the first detection range DRa and the second detection range DRb, and the overlap area where the first second detection range 2DRa and the second second detection range 2DRb overlap. In the example shown in FIG. 3, the second first detection range 1DRb and the first second detection range 2DRa correspond to the overlap area.

That is, the detection unit 11 may detect the target person P by using the occlusion range OR, one of the first detection range DRa and the second detection range DRb, and the overlap area where the first detection range DRa and the second detection range DRb overlap. The detection unit 11 may also detect the target person P on the boundary between the outside viewing angle range OVR of the first sensor 1a and the outside viewing angle range OVR of the second sensor 1b and at least one of the first detection range DRa and the second detection range DRb. In other words, the information processing apparatus 2 can detect in case the target person P enters the detection range DR of the pyroelectric sensor, and in case the target person P exits the detection range DR of the pyroelectric sensor.

The protective screen S is provided on the front side of the first sensor 1a and the second sensor 1b. The protective screen S covers the first sensor 1a and the second sensor 1b, preventing damage to the first sensor 1a and the second sensor 1b and blocking the entry of dusts.

### 2-3: Modified Example of the Occlusion Object O

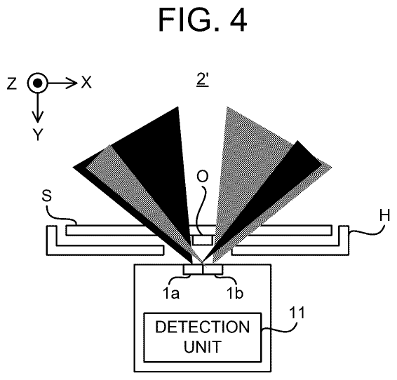

The occlusion object O may not have to be a part of the housing H. For example, as shown in FIG. 4, the information processing apparatus 2′ may be provided with the occlusion object O on the side of the first sensor 1a and the second sensor 1b of the protective screen S. In this case, the occlusion object O may be realized by printing it on the side of the protective screen S adjacent to the first sensor 1a and the second sensor 1b.

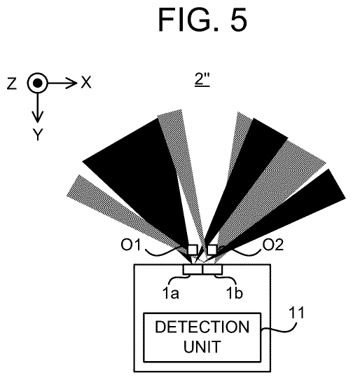

Furthermore, the occlusion object O may be provided in multiple numbers. For example, FIG. 5 illustrates a case where the information processing apparatus 2″ is provided with two occlusion objects O1 and O2. By increasing the number of the occlusion object O, the opportunity to detect the target person P can be increased.

Furthermore, by adjusting the X-axis dimension of the occlusion object O and the Y-axis dimension of the occlusion object O, the first detection range DRa and the second detection range DRb can be adjusted, thereby adjusting the detection range DR of the pyroelectric sensor. Furthermore, by adjusting the X-axis dimension of the occlusion object O and the Y-axis dimension of the occlusion object O, the overlap area can be adjusted, thereby enabling the timing for detecting the target person P to be adjusted.

The information processing apparatus 2 according to this embodiment can detect the target person P not only in case the target person P is moving along the Y-axis as shown in FIG. 3, but also in case the target person P is moving along the X-axis. That is, the information processing apparatus 2 can detect in case the target person P is approaching from the front of the information processing apparatus 2 and in case the target person P has crossed in front of the information processing apparatus 2.

### 2-4: Technical Effects of the Information Processing Apparatus 2

In case the pyroelectric sensor is adopted as the human sensor, it offers advantages such as lower cost compared to using an image camera as the human sensor. A Fresnel lens is often used to control the detection range of the pyroelectric sensor. In case of using a Fresnel lens, shaping it into a hemispherical form can impart desirable lens characteristics. On the other hand, in case of using such a Fresnel lens, there are often restrictions on the thinness of the apparatus on which the pyroelectric sensor is mounted and on the design freedom.

The information processing apparatus 2 according to the second embodiment is equipped with an occlusion object O, so that the target person P approaching from the front can be detected without enlarging the apparatus on which the pyroelectric sensor is mounted. The information processing apparatus 2 occludes part of the common detection range, enabling it to accurately detect the target person P approaching from the front of the information processing apparatus 2. The information processing apparatus 2 can detect the target person P at multiple locations, enabling accurate detection of the presence of the target person P. The information processing apparatus 2 detects the target person P using multiple different types of areas, enabling accurate detection of the presence of the target person P.

Applying the information processing apparatus 2 to the human sensor can reduce the number of parts and lead to cost reductions. In addition, the apparatus equipped with the pyroelectric sensor can be made thinner. Furthermore, the design freedom of the apparatus equipped with the pyroelectric sensor can be increased.

### 3: Third Example Embodiment

Next, the third embodiment of the information processing apparatus, information processing method, and recording medium will be described. In the following, the third embodiment of the information processing apparatus, information processing method, and recording medium will be described using an imaging apparatus 3 to which the third embodiment of the information processing apparatus, information processing method, and recording medium is applied.

The imaging system 3 images the target person P approaching the imaging system 3. The imaging system 3 may be applied to imaging the target person P passing through a facility gate. In case the imaging system 3 is applied to imaging the target person P passing through a gate, since the gate serves as the destination, the target person P can easily move toward the imaging system 3. Additionally, the imaging system 3 may be designed to be easily noticeable, making it easier for the target person P to move toward it. Furthermore, the imaging system 3 may be applied to a camera-equipped intercom, for example.

### 3-1: Configuration of the Imaging System 3

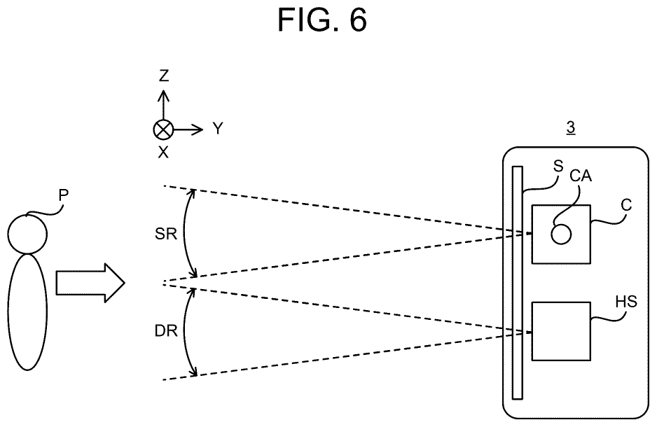

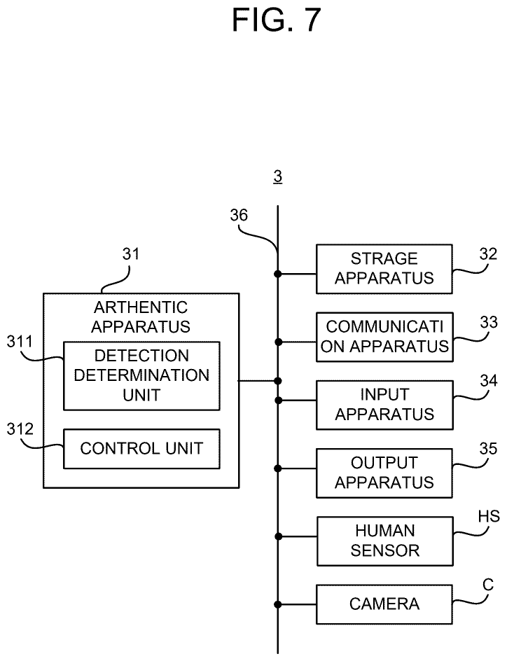

Referring to FIG. 6 and FIG. 7, the configuration of the imaging system 3 according to the third embodiment will be described. FIG. 6 is a cross-sectional view showing the configuration of the imaging system 3 according to the third embodiment. FIG. 7 is a block diagram showing the configuration of the imaging system 3 according to the third embodiment.

FIG. 6 shows an example in which the target person P is moving in the Y-axis direction (in the third embodiment, in the direction facing the front of the imaging system 3). As shown in FIG. 6, the imaging system 3 may be equipped with a camera C and a human sensor HS. The symbol SR in FIG. 6 illustrates the field of view range of the camera C. In the third embodiment, the camera C may be a visible camera. Alternatively, the camera C may be an infrared camera. The camera C may have a rotation axis CA. The rotation axis CA may be a mechanism for tracking persons of various heights. By having the rotation axis CA, the camera C may be able to capture both short children and tall adults.

However, in case the camera C is continuously operated, power consumption increases. In addition, the operating time of parts such as the rotation axis CA becomes longer, causing the parts to wear out quickly. In contrast, the imaging system 3 according to the third embodiment is equipped with the human sensor HS, which can determine whether the target person P is approaching. The imaging system 3 can drive the camera C in case the target person P approaches. The information processing apparatus 2 according to the second embodiment may be applied to the human sensor HS. The detection range DR in FIG. 6 is an example of the field of view of the human sensor HS.

The imaging system 3 may be provided with a protective screen S. The protective screen S is disposed on the front side of the camera C and the human sensor HS. The protective screen S covers the camera C and the human sensor HS, preventing damage to the camera C and the human sensor HS and preventing the entry of debris.

As shown in FIG. 7, the imaging system 3 includes an arithmetic apparatus 31 and a storage apparatus 32. Additionally, the imaging system 3 may include a communication apparatus 33, an input apparatus 34, and an output apparatus 35. However, the imaging system 3 may not include at least one of the communication apparatus 33, the input apparatus 34, and the output apparatus 35. The arithmetic apparatus 31, the storage apparatus 32, the communication apparatus 33, the input apparatus 34, the output apparatus 35, the human sensor HS, and the camera C may be connected via a data bus 36.

The arithmetic apparatus 31 may be, for example, a CPU (Central Processing Unit), a GPU (Graphics Processing Unit), and/or an FPGA (Field Programmable Gate Array). The arithmetic apparatus 31 reads a computer program. For example, the arithmetic apparatus 31 may read a computer program stored in the storage apparatus 32. For example, the arithmetic apparatus 31 may read a computer program stored in a computer-readable and non-temporary recording medium using a recording medium reading apparatus (e.g., the input apparatus 34 described later) provided in the imaging system 3. The arithmetic apparatus 31 may acquire (i.e., download or read) a computer program from an apparatus not shown, which is disposed outside the imaging system 3, via the communication apparatus 33 (or other communication apparatus). The arithmetic apparatus 31 executes the read computer program. As a result, logical functional blocks for executing the operations to be performed by the imaging system 3 are realized within the arithmetic apparatus 31. In other words, the arithmetic apparatus 31 functions as a controller for realizing logical functional blocks for executing the operations (i.e., processing) to be performed by the imaging system 3.

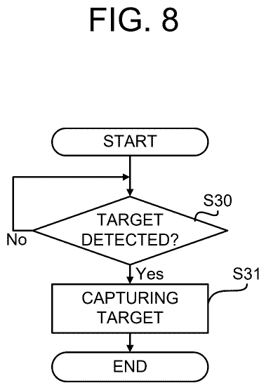

FIG. 7 shows an example of logical function blocks realized within the arithmetic apparatus 31 for executing information processing operations. As shown in FIG. 6, the arithmetic apparatus 31 includes a detection determination unit 311 and a control unit 312, which is a specific example of the “control unit” described in the Supplementary Note below. The details of the operations of the detection determination unit 311 and the control unit 312 will be explained later with reference to FIG. 8.

The storage apparatus 32 is capable of storing desired data. For example, the storage apparatus 32 may temporarily store a computer program executed by the arithmetic apparatus 31. The storage apparatus 32 may temporarily store data temporarily used by the arithmetic apparatus 31 in case the arithmetic apparatus 31 is executing a computer program. The storage apparatus 32 may store data to be stored long-term by the imaging system 3. The storage apparatus 32 may include at least one of a RAM (random access memory), a ROM (read-only memory), a hard disk apparatus, an optical magnetic disk apparatus, SSD (Solid State Drive), and disk array apparatus. In other words, the storage apparatus 32 may include non-temporary recording media.

The communication apparatus 33 is capable of communicating with apparatus external to the imaging system 3 via a communication network (not shown). The communication apparatus 33 may be a communication interface based on standards such as Ethernet (registered trademark), Wi-Fi (registered trademark), Bluetooth (registered trademark), and USB (Universal Serial Bus).

The input apparatus 34 is an apparatus that accepts information input to the imaging system 3 from outside the imaging system 3. For example, the input apparatus 34 may include an operation apparatus (e.g., at least one of a keyboard, a mouse, and a touch panel) that can be operated by an operator of the imaging system 3. For example, the input apparatus 34 may include a reading apparatus capable of reading information recorded as data on a recording medium that can be attached to the information processing apparatus 2.

The output apparatus 35 is an apparatus that outputs information to the outside of the imaging system 3. For example, the output apparatus 35 may output information as images. In other words, the output apparatus 35 may include a display apparatus (a so-called display) capable of displaying images indicating the information to be output. For example, the output apparatus 35 may output information as sound. In other words, the output apparatus 35 may include a sound apparatus (a so-called speaker) capable of outputting sound. For example, the output apparatus 35 may output information onto paper. In other words, the output apparatus 35 may include a printing apparatus (so-called printer) capable of printing desired information on paper.

### 3-2: Information Processing Operation Performed by the Imaging System 3

With reference to FIG. 8, the information processing operation performed by the imaging system 3 according to the third embodiment will be described. FIG. 8 is a flowchart showing the information processing operation performed by the imaging system 3 according to the third embodiment.

As shown in FIG. 8, the detection determination unit 311 determines whether the human sensor HS has detected the target person P (step S30). In case the human sensor HS has detected the target person P (step S30: Yes), the control unit 312 controls the camera C to capture an image of the target person P (step S31).

FIG. 6 illustrates a situation where the target person P is moving along the Y-axis direction, but the human sensor HS may detect the target person P moving in a direction different from the Y-axis direction. Additionally, the human sensor HS may detect the target person P moving along the X-axis direction (the direction in which the first sensor 1a and the second sensor 1b are aligned).

As described above, the human sensor HS can detect both in case the target person P enters the detection range DR of the pyroelectric sensor and in case the target person P exits the detection range DR of the pyroelectric sensor. For example, in case the human sensor HS detects that the target person P has entered the detection range DR and then exits the detection range DR within a predetermined time, the imaging system 3 can estimate that the target person P is moving in the direction in which the first sensor 1a and the second sensor 1b are aligned. In this case, the imaging system 3 may, for example, induce the target person P to face the direction of the imaging system 3.

### 3-3: Technical Effects of the Imaging System 3

In many cases, the camera C is adopted for the purpose of security, etc., to detect persons in the vicinity. In this case, in case the camera C is kept running continuously, power consumption increases, and the wear and tear of drive components for tracking persons accelerates. There is a need for an inexpensive the human sensor to suppress power consumption and extend the service life of drive components.

The imaging system 3 according to the third embodiment uses the information processing apparatus 2 of the second embodiment as the human sensor HS. The imaging system 3 images the target person P in case the human sensor HS detects the target person P, thereby suppressing unnecessary operation of the camera C.

### 4: Fourth Example Embodiment

Next, the fourth embodiment of the information processing apparatus, information processing method, and recording medium will be described. In the following, the fourth embodiment of the information processing apparatus, information processing method, and recording medium will be described using an imaging apparatus 4 to which the fourth embodiment of the information processing apparatus, information processing method, and recording medium is applied.

### 4-1: Configuration of the Imaging System 4

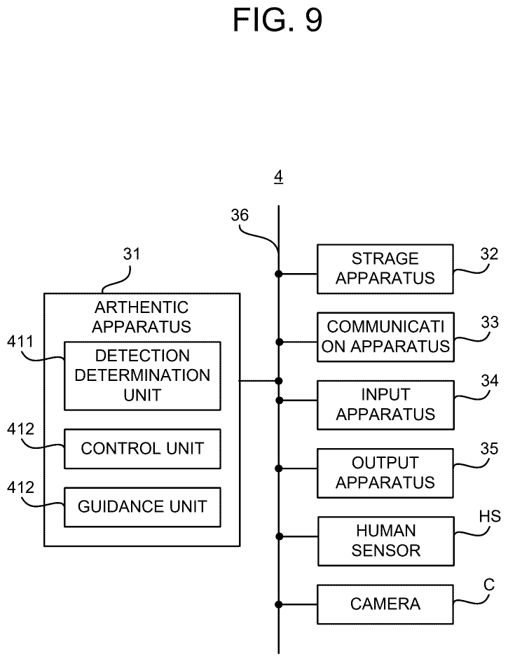

As shown in FIG. 9, the imaging system 4 according to the fourth embodiment is provided with the arithmetic apparatus 31 and the storage apparatus 32, as in the imaging system 3 according to the third embodiment. In addition, the imaging system 4 according to the fourth embodiment may be equipped with the human sensor HS and the camera C as an imaging means, as in the imaging system 3 according to the third embodiment. Furthermore, the imaging system 4 according to the fourth embodiment may include the communication apparatus 33, the input apparatus 34, and the output apparatus 35, as in the imaging system 3 according to the third embodiment. However, the imaging system 4 may not necessarily include at least one of the communication apparatus 33, the input apparatus 34, and the output apparatus 35. The imaging system 4 according to the fourth embodiment differs from the imaging system 3 according to the third embodiment in that a guidance unit 413, which is a specific example of the guidance unit described in the Supplementary Note below, is further provided in the arithmetic apparatus 31. The other features of the imaging system 4 may be the same as the other features of the imaging system 3 according to the third embodiment. For this reason, the following description will explain in detail the parts that differ from the embodiments already described, and omit explanations of other overlapping parts as appropriate.

In the fourth embodiment, the first sensor 1a, the second sensor 1b, and the occlusion object O provided in the human sensor HS are provided such that the overlap area where the first detection range DRa and the second detection range DRb overlap becomes the focus range of the camera C.

### 4-2: Information Processing Operation Performed by the Imaging System 4

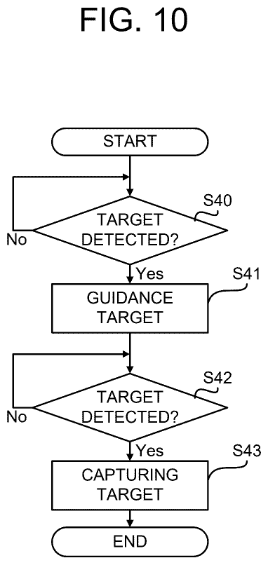

Referring to FIG. 10, the information processing operation performed by the imaging system 4 according to the fourth embodiment will be described. FIG. 10 is a flowchart showing the flow of the information processing operation performed by the imaging system 4 according to the fourth embodiment.

As shown in FIG. 10, a detection determination unit 411 determines whether the human sensor HS has detected the target person P in either the first detection range DRa or the second detection range DRb (step S40). In case the human sensor HS detects the target person P in either the first detection range DRa or the second detection range DRb (step S40: Yes), the guidance unit 413 guides the target person P to the overlap area (step S41).

The detection determination unit 411 determines whether the human sensor HS has detected the target person P in the overlap area (step S42). In case the human sensor HS detects the target person P in the overlap area (step S42: Yes), the control unit 412 controls the imaging of the camera C to capture the target person P (step S43). Since the overlap area is the focus range of the camera C, the camera C can capture the target person P existing in the focus range of the camera C.

### 4-3: Technical Effects of the Imaging System 4

The imaging system 4 according to the fourth embodiment guides the target person P into the focus range of the camera C, so that a high-quality image of the target person P can be captured.

### 5: Fifth Example Embodiment

Next, the fifth embodiment of the information processing apparatus, information processing method, and recording medium will be described. In the following, the fifth embodiment of the information processing apparatus, information processing method, and recording medium will be described using a recognition system 5 to which the fifth embodiment of the information processing apparatus, information processing method, and recording medium is applied.

### 5-1: Configuration of the Recognition System 5

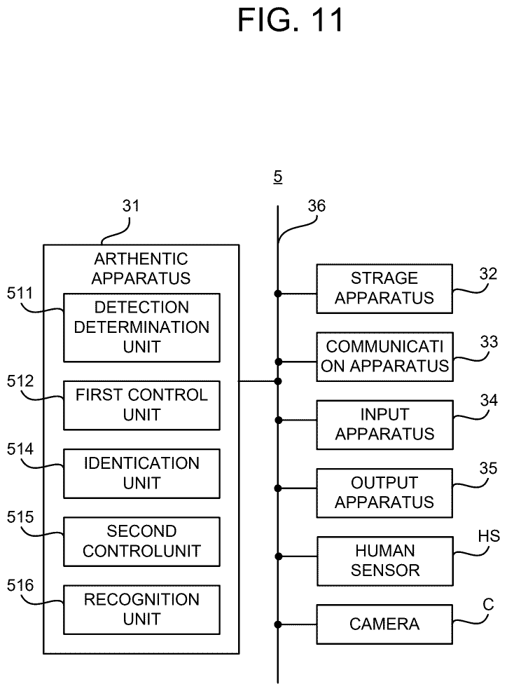

As shown in FIG. 11, the recognition system 5 according to the fifth embodiment is provided with the arithmetic apparatus 31 and the storage apparatus 32, as in the imaging system 3 according to the third embodiment and the imaging system 4 according to the fourth embodiment. Furthermore, the recognition system 5 according to the fifth embodiment may include the communication apparatus 33, the input apparatus 34, and the output apparatus 35, as in the imaging system 3 according to the third embodiment and the imaging system 4 according to the fourth embodiment. However, the recognition system 5 may not include at least one of the communication apparatus 33, the input apparatus 34, and the output apparatus 35. In addition, the recognition system 5 according to the fifth embodiment may be equipped with the human sensor HS, as in the imaging system 3 according to the third embodiment and the imaging system 4 according to the fourth embodiment. In addition, the recognition system 5 according to the fifth embodiment may be equipped with a visible camera VC as a first imaging means and an infrared camera IC as a second imaging means. The recognition system 5 according to the fifth embodiment includes, within the arithmetic apparatus 31, a first control unit 512, which is a specific example of the first control unit described in the Supplementary Note described below, an identification unit 514, which is a specific example of the identification unit described in the Supplementary Note described below, a second control unit 515, which is a specific example of the second control unit described in the Supplementary Note described below, and a recognition unit 516, which is a specific example of the recognition unit described in the Supplementary Note described below. Other features of the recognition system 5 may be the same as at least one other feature of the imaging system 3 according to the third embodiment and the imaging system 4 according to the fourth embodiment. For this reason, the following description will detail the parts that differ from the embodiments already described, omitting explanations of other overlapping parts as appropriate.

In the fifth embodiment, the first sensor 1a, the second sensor 1b, and the occlusion object O provided by the human sensor HS may be provided such that the overlap area where the first detection range DRa and the second detection range DRb overlap becomes the focus range of the infrared camera IC.

### 5-2: Information Processing Operation Performed by the Recognition System 5

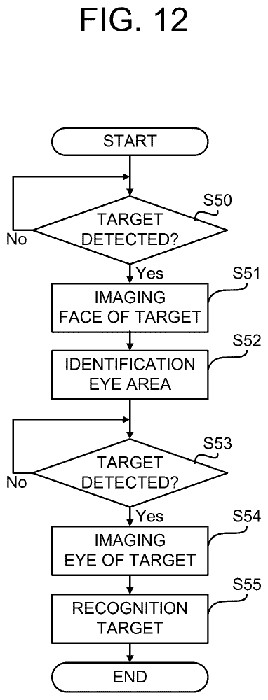

Referring to FIG. 12, the information processing operation performed by the recognition system 5 according to the fifth embodiment will be described. FIG. 12 is a flowchart showing the flow of the information processing operation performed by the recognition system 5 according to the fifth embodiment.

As shown in FIG. 12, the detection determination unit 511 determines whether the human sensor HS has detected the target person P in either of the first detection range DRa of the first sensor 1a that is not occluded by the occlusion object O, or the second detection range DRb of the second sensor 1b that is not occluded by the occlusion object O (step S50). In case the human sensor HS detects the target person P in either the first detection range DRa or the second detection range DRb (step S50: Yes), the first control unit 512 controls the visible camera VC to capture a face image of a face of the target person P (step S51). The identification unit 514 identifies the position of the eye area of the target person P using the face image (step S52).

The detection determination unit 511 determines whether the human sensor HS has detected the target person P in the overlap area where the first detection range DRa and the second detection range DRb overlap (step S53). In case the human sensor HS detects the target person P in the overlap area (step S53: Yes), the second control unit 515 controls the infrared camera IC to capture an eye image of an eye area of the target person P (step S54). The recognition unit 516 performs an iris recognition of the target person P using the eye image (step S55).

In this embodiment, the visible camera VC and the infrared camera IC are used, but a single camera C may be used to acquire the face image and the eye image. In addition, in case the human sensor HS detects the target person P in either the first detection range DRa or the second detection range DRb, the target person P may be guided to the overlap area as in the fourth embodiment, along with the acquisition of the face image.

In addition, the recognition system 5 may perform a face recognition using images captured by the visible camera VC. In other words, the recognition system 5 may perform a multimodal recognition.

### 5-3: Technical Effects of the Recognition System 5

The recognition system 5 according to the fifth embodiment can accurately detect the target person P using a human sensor HS that detects the target person P in accordance with the detection result of the first sensor 1a, whose detection range is partially occluded by the occlusion object O, and the detection result of the second sensor 1b, whose detection range is partially occluded by the occlusion object O and therefore an image suitable for recognition can be captured, and the target person P can be recognized accurately. The recognition system 5 identifies the eye region from the face image of the target person P located relatively far from the recognition system 5, and captures the eye region in case the target person P approaches relatively close, so that even in case the target person P is walking, it is possible to acquire an eye image suitable for the iris recognition and perform the iris recognition with high accuracy.

The imaging system 3 of the third embodiment and the imaging system 4 of the fourth embodiment may perform at least one of the face recognition and the iris recognition using images taken by the camera C, as in the recognition system 5 of the fifth embodiment. In other words, the imaging system 3 and the imaging system 4 may perform the face recognition, the iris recognition, or the multimodal recognition including the face recognition and the iris recognition.

### 6: Supplementary Note

The following supplementary note is disclosed regarding the embodiments described above.

### ps Supplementary Note 1

An information processing apparatus including:
a first sensor;
a second sensor;
an occlusion object that occludes a part of a detection range of the first sensor and a part of a detection range of the second sensor; and
a detection unit that detects a target according to a detection result of the first sensor in case the part of the detection range of the first sensor is occluded by the occlusion object and a detection result of the second sensor in case the part of the second detection range of the second sensor is occluded by the occlusion object.

### Supplementary Note 2

The information processing apparatus according to Supplementary Note 1, wherein
the first sensor and the second sensor are provided side by side, and
the detection unit detects the target according to a difference between the detection result of the first sensor in case the part of the detection range of the first sensor is occluded by the occlusion object and the detection result of the second sensor in case the part of the detection range of the second sensor is occluded by the occlusion object.

### Supplementary Note 3

The information processing apparatus according to Supplementary Note 1 or 2, wherein the occlusion object occludes a part of a common detection range between the detection range of the first sensor and the detection range of the second sensor.

### Supplementary Note 4

The information processing apparatus according to Supplementary Note 1 or 2, wherein the detection unit detects the target present at a boundary between a occluded range occluded by the occlusion object and at least one of a first detection range of the first sensor that is not occluded by the occlusion object and a second detection range of the second sensor that is not occluded by the occlusion object, and at a boundary between an outside detection range area that is an outside detection range of the first sensor and an outside detection range of the second sensor and the at least one of the first detection range and the second detection range.

### Supplementary Note 5

The information processing apparatus according to Supplementary Note 1 or 2, wherein the detection unit detects the target using a occluded range occluded by the occlusion object, one of a first detection range of the first sensor that is not occluded by the occlusion object and a second detection range of the second sensor that is not occluded by the occlusion object, and an overlap area where the first detection range and the second detection range overlap.

### Supplementary Note 6

The information processing apparatus according to Supplementary Note 1 or 2, further including a control unit that controls an imaging unit for imaging the target in case the detection unit detects the target.

### Supplementary Note 7

The information processing apparatus according to Supplementary Note 6, wherein
the first sensor, the second sensor, and the occlusion object are aligned such that an overlap area where a first detection range of the first sensor that is not occluded by the occlusion object and a second detection range of the second sensor that is not occluded by the occlusion object overlap each other is within a focal range of the imaging unit, further including
a guidance unit that guides the target to the overlap area in case the detection unit detects the target in either the first detection area or the second detection area, wherein
the control unit controls the imaging of the imaging unit in case the detection unit detects the target in the overlap area.

### Supplementary Note 8

The information processing apparatus according to Supplementary Note 1 or 2, further including:
a first control unit that controls a first imaging unit for capturing a face image of a face of the target and acquires the face image in case the detection unit detects the target in either a first detection range of the first sensor that is not occluded by the occlusion object or a second detection range of the second sensor that is not occluded by the occlusion object;
an identification unit that identifies a position of an eye area of the target using the face image;
a second control unit that controls a second imaging unit for capturing an eye image of the eye area of the target identified by the identification unit in case the detection unit detects the target in an overlap area where the first detection range and the second detection range overlap, and acquires the eye image; and
a recognition unit that performs an iris recognition using the eye image; and wherein
the first sensor, the second sensor, and the occlusion object are aligned so that the overlap area is within a focal range of the second imaging unit.

### Supplementary Note 9

An information processing method including:
detecting a target according to a detection result of a first sensor in case a part of a detection range of the first sensor is occluded by an occlusion object and a detection result of a second sensor in case a part of a detection range of the second sensor is occluded by the occlusion object, wherein the occlusion object occludes the part of the detection range of the first sensor and the part of the detection range of the second sensor.

### Supplementary Note 10

A recording medium on which a computer program is stored, the computer program being configured to allow a computer to execute an information processing method including:
detecting a target according to a detection result of a first sensor in case a part of a detection range of the first sensor is occluded by an occlusion object and a detection result of a second sensor in case a part of a detection range of the second sensor is occluded by the occlusion object, wherein the occlusion object occludes the part of the detection range of the first sensor and the part of the detection range of the second sensor.

This disclosure may be changed as appropriate within the scope that does not contradict the technical idea that can be read from the claims and the entire description. The information processing apparatus, information processing method, and recording medium with such changes are also included in the technical idea of this disclosure.

### Description of Reference Codes

1, 2 information processing apparatus
1a, 100a first sensor
1b, 100b second sensor
O occlusion object
11, 1001 detection unit
3, 4 imaging system
5 recognition system
HS human sensor
311, 411, 511 detection determination unit
312, 412 control unit
413 guidance unit
512 first control unit
514 identification unit
515 second control unit
516 recognition unit

What is claimed is:

1. An information processing apparatus comprising:
a first sensor;
a second sensor;
an occlusion object that occludes a part of a detection range of the first sensor and a part of a detection range of the second sensor;
at least one memory storing instructions; and
at least one processor that is configured to execute the instructions to
detect a target according to a detection result of the first sensor in case the part of the detection range of the first sensor is occluded by the occlusion object and a detection result of the second sensor in case the part of the second detection range of the second sensor is occluded by the occlusion object.

2. The information processing apparatus according to claim 1, wherein
the first sensor and the second sensor are provided side by side, and
the at least one processor that is configured to execute the instructions to detect the target according to a difference between the detection result of the first sensor in case the part of the detection range of the first sensor is occluded by the occlusion object and the detection result of the second sensor in case the part of the detection range of the second sensor is occluded by the occlusion object.

3. The information processing apparatus according to claim 1, wherein the occlusion object occludes a part of a common detection range between the detection range of the first sensor and the detection range of the second sensor.

4. The information processing apparatus according to claim 1, wherein the at least one processor that is configured to execute the instructions to detect the target present at a boundary between a occluded range occluded by the occlusion object and at least one of a first detection range of the first sensor that is not occluded by the occlusion object and a second detection range of the second sensor that is not occluded by the occlusion object, and at a boundary between an outside detection range area that is an outside detection range of the first sensor and an outside detection range of the second sensor and the at least one of the first detection range and the second detection range.

5. The information processing apparatus according to claim 1, wherein the at least one processor that is configured to execute the instructions to detect the target using a occluded range occluded by the occlusion object, one of a first detection range of the first sensor that is not occluded by the occlusion object and a second detection range of the second sensor that is not occluded by the occlusion object, and an overlap area where the first detection range and the second detection range overlap.

6. The information processing apparatus according to claim 1, wherein the at least one processor that is configured to execute the instructions to control a camera for imaging the target in case of a detection the target.

7. The information processing apparatus according to claim 6, wherein
the first sensor, the second sensor, and the occlusion object are aligned such that an overlap area where a first detection range of the first sensor that is not occluded by the occlusion object and a second detection range of the second sensor that is not occluded by the occlusion object overlap each other is within a focal range of the camera, and,
the at least one processor that is configured to execute the instructions to: guide the target to the overlap area in case of a detection the target in either the first detection area or the second detection area; and
control the imaging of the camera in case of a detection the target in the overlap area.

8. The information processing apparatus according to claim 1, wherein the at least one processor that is configured to execute the instructions to:
control a first camera for capturing a face image of a face of the target;
acquire the face image in case of a detection the target in either a first detection range of the first sensor that is not occluded by the occlusion object or a second detection range of the second sensor that is not occluded by the occlusion object;
identify a position of an eye area of the target using the face image;
control a second camera for capturing an eye image of the eye area of the target identified in case of a detection the target in an overlap area where the first detection range and the second detection range overlap,
acquire the eye image; and
perform an iris recognition using the eye image; and
the first sensor, the second sensor, and the occlusion object are aligned so that the overlap area is within a focal range of the second camera.

9. An information processing method comprising
detecting a target according to a detection result of a first sensor in case a part of a detection range of the first sensor is occluded by an occlusion object and a detection result of a second sensor in case a part of a detection range of the second sensor is occluded by the occlusion object, wherein the occlusion object occludes the part of the detection range of the first sensor and the part of the detection range of the second sensor.

10. A non-transitory recording medium on which a computer program is stored, the computer program being configured to allow a computer to execute an information processing method comprising
detecting a target according to a detection result of a first sensor in case a part of a detection range of the first sensor is occluded by an occlusion object and a detection result of a second sensor in case a part of a detection range of the second sensor is occluded by the occlusion object, wherein the occlusion object occludes the part of the detection range of the first sensor and the part of the detection range of the second sensor.
